(19) United States
(12) Patent Application Publication
(10) Pub. No.: US 2012/0284758 A1
(43) Pub. Date: Nov. 8, 2012

(54) SYSTEM TO ENHANCE TELEVISION VIEWING BY MERGING TELEVISION AND THE INTERNET

(76) Inventor: Eric Adjesson, Alpharetta, GA (US)

(21) Appl. No.: 13/466,099

(22) Filed: May 7, 2012

Related U.S. Application Data
(60) Provisional application No. 61/483,236, filed on May 6, 2011.

(51) Int. Cl. H04N 21/433; H04N 21/20

(52) U.S. Cl. 725/89; 725/93

(57) ABSTRACT

A system merges television and the internet in such a way that the two are interactive with one another. The application-based system can bring true entertainment and the power to own a piece of all potential shows and movies to every home. The system will present viewers with the option to purchase objects that are available on any given show in the application's inventory. Viewers will also have the chance to purchase alternate items if the originals are pricy or unavailable. If objects in inventory are not of interest to a viewer at the time, they can view links provided on the system for information purposes. The system is a shopping ground and unique information haven for those who are entertained by movies, television shows, documentaries and the news. The information provided will come from sets of servers and other sites via an application specific to that entertainment.

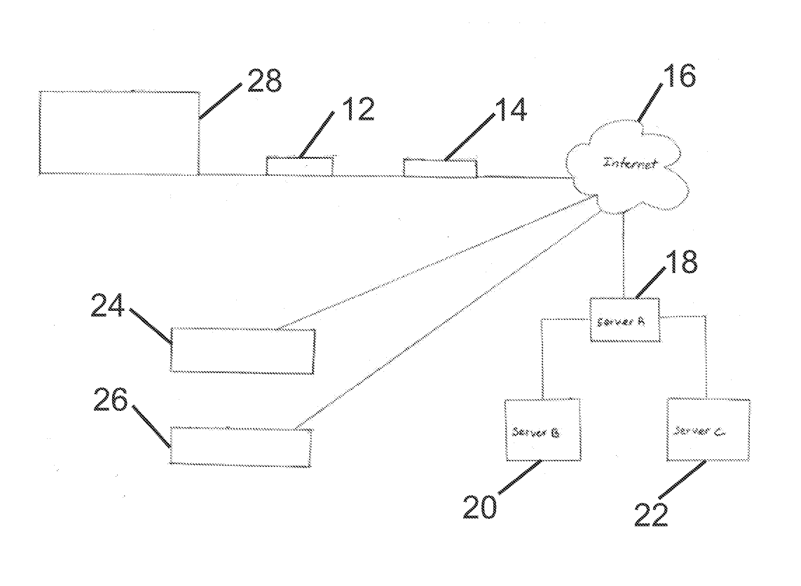

### CROSS-REFERENCE TO RELATED APPLICATIONS

This application claims the benefit of priority of U.S. provisional patent application No. 61/483,236, filed May 6, 2012, the contents of which are herein incorporated by reference.

### BACKGROUND OF THE INVENTION

The present invention relates to television viewing systems and, more particularly, to a system to enhance television viewing by merging television and the internet in such a way that the two are interactive with one another.

Currently, there are attempts by other corporations to merge television and the power of the internet; these companies only managed to provide format that makes it easy to view content of the internet on television sets. These conventional systems do not allow a user the opportunity to view information about the entertainment being viewed.

As can be seen, there is a need for a system that can provide users specific information about the entertainment the user is viewing.

### SUMMARY OF THE INVENTION

In one aspect of the present invention, a purchasing system for a media viewer comprises a storage unit for storing data about entertainment viewed by the viewer; a first server configured receive inquiries from the viewer and retrieve information; a second server configured to house links to items present in all entertainment and shows on channels that the system supports; and a third server configured to distribute the viewer's request to a known source or preferred provider for purchase or fulfillment.

In another aspect of the present invention, an entertainment system comprises a storage unit; software written in one or more computer codes and stored on computer readable media in the storage unit, the software having code segments to provide a graphical user interface to a viewer to select an object to obtain information about the object; a first server configured receive inquiries from the viewer and retrieve information; a second server configured to house links to items present in all entertainment and shows on channels that the system supports; and a third server configured to distribute the viewer's request to a known source or preferred provider for purchase or fulfillment.

These and other features, aspects and advantages of the present invention will become better understood with reference to the following drawing, description and claims.

### BRIEF DESCRIPTION OF THE DRAWING

The FIGURE is a schematic representation of a television entertainment system according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system that merges television and the internet in such a way that the two are interactive with one another. The application-based system can bring true entertainment and the power to own a piece of all potential shows and movies to every home. The system will present viewers with the option to purchase objects that are available on any given show in the application's inventory. Viewers will also have the chance to purchase alternate items if the originals are pricy or unavailable. If objects in inventory are not of interest to a viewer at the time, they can view links provided on the system for information purposes. In essence, the system is the ultimate shopping ground and unique information haven for those who are entertained by movies, television shows, documentaries and the news. The information that will be provided will come from sets of servers and other sites via an application specific to that entertainment; the type of information provided will depend on the inquiries of the end-user.

The system of the present invention provides an entertainment information system that provides end-users with specific information about objects that is present in a given motion picture (TV shows, movies, documentaries, commercials etc. . . . ). The system will not only be a source of knowledge for the end users about objects that are shown on their television screen; it will also be a means of shopping for those items when available.

Referring to the FIGURE, the system 10 of the present invention is an entertainment system that allows interaction between end-user and their visual acoustic base entertainment on many levels. The system 10 will allow the end user's television set 28 to become the focal point of his or her entertainment, shopping and information center. The realization of the system of the present invention is the perfect opportunity to satisfy a market that is currently being serviced through many different avenues. The system of the present invention will consolidate those avenues and meet the entertainment need of consumers through a multi-functional unit and its main ability to become a single point of purchase (POS). The system 10 of the present invention includes three parts: a box 12 connected to the internet 16 via a cable 14, for example; the software, typically written into the box 12; and the supporting system, which includes server A 18, server B 20 and server C 22, for example.

The box set 12 is an electronic component or device that can be connected to the television 28 via USB, or HDMI cable, for example. The box 12 can host the software that will allow it to perform various tasks.

The box 12 can be a storage unit with the ability to store TV shows, movies, documentaries and commercials on its hard drive, similar to a digital video recorder (DVR). The box 12 will also be capable of storing PC-based games through a service provider. Alternatively, the box 12 can simply be a small electronic device that can be connected to a DVR, a gaming console or be directly connected to a television via USB, or HDMI cable. The box 12 can simply be a programmable commercial set top television box such as the VIA ARTIGO 1150 from VIA Technologies. The box 12 will also be the avenue through which the end users remote control will interact with the system.

The software of the present invention will be hosted by the box 12 and have the ability to detect shows that are being viewed or uploaded to the television 28 based on its title and seamlessly pull the application programmed for the particular entertainment. The application will remain in the background of the entertainment until it is needed by the end-user. When activated by the “menu” button, for example, the application will appear at the forefront of the television screen. This application GUI will allow the end user to interact with the system and pull enquiries from the supporting system.

The supporting system is the brain of the system of the present invention. The supporting system includes three supporting servers. Server “A” can be designed specifically to receive inquiries from the end user though the application and, in turn, retrieve the information from either server “B” or third party sites. This server will house compounded information about any items or object in all entertainment, TV channels, and TV shows that the system supports. This server will know the location of all supported items based on the items themselves. For example, all music enquiries could go to Rhapsody or Amazon music. Books and video enquiries could go to Amazon.com and the history channels, for example.

Server “B” can house the links to all items that are present in all entertainment and shows on channels that the system supports and will be updated regularly for new shows that the system will support and all newly discovered items. This server will also house enquiries that the system was not able to fulfill with preselected vendors. In this case, the system staff can look into the enquiry and try to fulfill them through other vendors and update the server with new vendors and items for future similar enquiries.

Server “C” can receive all enquiries information by the end-users from Server “A” and communicate with end user's accounts. This Server will send purchase enquiry confirmation to the end-user's account. This server will be the means through which end users of the system will communicate with the system's staff if need be. The final functionality of this server is to track all inquiries, purchases and traffic generated to a particular vendor's website.

To use the system of the present invention, the box is connected to a TV set via a USB or HDMI cable. The box can identify the title of the TV shows or movies on the television and the time track of the show or movie. Once an entertainment is detected, the system will preload the application for that entertainment form Server “A”. When the end user hears a song of interest, for example, he can pause the entertainment, and press the menu button on his system remote control. The system's application GUI appears on the far front of the screen, presenting the end user with the onscreen translucent menu that will allow him to navigate choices and make enquiries. In this case, he will navigate to “Current Seen” then “Object”. From here, he will select music, all the music heard within each half hour time block in the movie will be available for him. He will select the song of interest using his remote control; the application will pull the song on “Rhapsody” using a predetermined query for that song. For example, the query could be: http://www.rhapsody.com/artist/various-artists/album/wall-street-money-never-sleeps-music-from-the-motion-picture/track/home.

The end user will have the opportunity to listen to the selected song and purchase it in a downloadable format such as an MP3 from “Rhapsody”. The song will be downloaded to his account hosted on Server “C”. If the user wants to buy the entire album, he will have an available link to “Amazon” where he will be able to buy a hard copy of the album to be sent to the home address provided in the user's account. The same process will be applied to many similar items such as apparel, vehicles, furniture and accessories, where the manufacture webpage will be the primary source of information and purchases.

In case of items that are not on the manufacture webpage; prior research will be done by the system's team and made available on Server “B”. If no information is found, similar items will be available.

Information that will be loaded to the application can be gathered from the producers of supported shows and movies. The system can provide supported category of items with links for the system application that will connect the respective items to the vendor's websites or to Server “B”, where the system will have resources available for items that are not supported by vendor's web pages.

TV networks can give a list of shows that will run ahead of time for research to be done to allow the system to be populated with the necessary links for the items that will be supported. Information such as ‘fact check’ of topics and claims being made will have links to documented truths. News channels will have the option to populate their own application or approve the information that is going to be uploaded to their system application due to the sensitive nature of the type of information and accuracy.

The system of the present invention will fulfill and exceed end-users dreams of interacting with their entertainment. The system will give the end-user the ability to select items that are being viewed on their television and pull any information desired about any supported items on the said entertainment source. End users will have the ability to experience objects through articles and other literature available at the time. The end-user may also experience the object or items through purchases, rentals or visit depending on the object in question. When the system is not being used to watch TV, it will serve as a web browsing tool or a gaming consol. Where it will allow users to purchase online games and serve as the console on which the games are played.

There are three ways to access objects and information in the system of the present invention. The quickest way is to pause the entertainment when an object of interest is on the screen, and, in the case of songs, when the sound of interest is heard. The end user will then be able to press the menu button on a remote or wireless keyboard; a GUI will appear, the user will select “current screen” on the GUI and scroll to “objects” and then “music” a list of music that is played will be available. He can then select the songs and play a sample of them. If the song he wanted is confirmed, the user can download or buy a hard copy to be sent to his home address. In the case of an object, after the entertainment is paused and the menu button is pressed, the user can use the navigation key to highlight the different objects visible on the screen and select enter on the remote control to have access to the object.

The second way to gain access to objects is by pressing the menu button. This will open the selection menu to the right side of the screen in a transparent GUI that displays the list of object. Objects can then be selected from there for information or purchases.

The third way to access objects is to select the transparent ‘Menu’ button that will appear at the end of the entertainment. A GUI will appear with a listing of objects classified by type. Objects will be available for selection and will eventually be identifiable by icon or thumb size picture.

The below provides examples of how the system of the present invention could be used. The below are examples only and other ways of using the system of the present invention are also contemplated.

An end-user just saw a dream vacation resort in the movie she is watching. She quickly brings the topic to her significant other's attention. The two will be able to purchase a vacation package to visit that famous area that she just saw in the movie currently playing on her TV set. With the use of her remote or wireless key board, she selects the onscreen menu button and navigates to ‘Current Scenery’. The system will provide her with information about the current scene location and other relevant information such as climate, population, income level, locals, and the like. She then selects the ‘Vacation’ option and the system guides her through a simple GUI that allowed her to make a vacation package purchase with select hotels, and the like.

Half an hour into her favorite show, another end-user hears a song that triggered an emotion she hasn't felt in a while and wants to buy the song. Through the system of the present invention, she easily pauses the show with her remote, selects the on screen menu button and navigates to ‘Current Music’. She then selects the song in question and listens to it. She downloads the single to quench her immediate need and buys the entire album to be shipped to her. She is also able to access other information related to the song such as album, artist, producer, inspiration, and the like.

In the first five minute of Bad Boys II, another end-user sees a couple of cars that will fit perfectly in his collection. He wants to buy the cars. Immediately, he pauses the movie and gets into the ‘Current Screen’ menu. With the use of his wireless keyboard or remote, he is able to scroll through the menu of available items and find the car and get valuable information about the collectable cars. He will also know if the car is available for sale and the asking price. The seller and potential buyer can communicate through the system. The end-user and the owner can reach an agreement on price via an email proxy server. The transaction can then be concluded based on the agreement.

This user was also interested in the history of the car and the actor “Will Smith”. The system is able to provide him with detailed information about the car and pull a biography of Will Smith for purchase.

There are various objects that the application can provide information about. Examples of these objects include songs, movies, videos, characters, architecture designs, biographies, homes, cars, furniture, designer clothes, decorative items, collectibles, autographed collectables, video games, and the like.

There is various pieces of information that can be provided about the various objects a user can select. This information can include producers, manufacturer, sponsors, interior and exterior decorators, designers, architects, engineers, actors, decorators, services, manufactures, availabilities, contact information, cost, articles, videos, biographies, fact checks, and the like.

Upon a purchase request by an end user, the system will filter the data of available items that were selected for purchase by the end user. This data is then classified by type (movie, song, cars, article of interest, vacation package, and the like) and the system will then send the list of requested purchases to pre-selected or preferred vendors 26 who can satisfy the end users list. If the preferred vendors are not able to satisfy all items on the list, secondary vendors may get the remaining items on the list. As a last resort, a researcher in a call center 24, for example, may look for the item on the list and email results to the end user's email address while the entertainment is still on. End users will then make the final purchasing decisions.

The box 12 will be linked to supporting system through an internet provider via Ethernet cable or wireless router 14, for example, and a network provider, such as dish or cable provider, through coax or HDMI cable. The box 12 will download the appropriate application file for the entertainment being viewed to its hardware from the system's supporting systems (Servers A, B, C). The application will operate from within the box 12 and relay information between the GUI and the system. If the end user is watching a DVD or a Blue ray disc, the system will be able to detect the movie title and provide similar services to the end user.

It should be understood, of course, that the foregoing relates to exemplary embodiments of the invention and that modifications may be made without departing from the spirit and scope of the invention as set forth in the following claims.

What is claimed is:

1. A purchasing system for a media viewer, comprising:
a storage unit for storing data about entertainment viewed by the viewer;
a first server configured receive inquiries from the viewer and retrieve information;
a second server configured to house links to items present in all entertainment and shows on channels that the system supports; and
a third server configured to distribute the viewer's request to a known source or preferred provider for purchase or fulfillment.

2. The purchasing system of claim 1, wherein the storage unit is a set-top box attached to a television.

3. The purchasing system of claim 1, wherein the storage unit allows a user to pause the entertainment being viewed.

4. The purchasing system of claim 1, further comprising software written in one or more computer codes and stored on computer readable media in the storage unit, the software having code segments to provide a graphical user interface to the viewer to select an object to obtain information about the object.

5. The purchasing system of claim 4, wherein the object is selected from the group consisting of songs, movies, videos, characters, architecture designs, biographies, homes, cars, furniture, designer clothes, decorative items, collectibles, autographed collectables, and video games.

6. The purchasing system of claim 4, wherein the information is selected from the group consisting of decorators, designers, architects, engineers, actors, decorators, services, manufactures, availabilities, contact information, cost, articles, videos, biographies, and fact checks.

7. The purchasing system of claim 1, wherein the second server is updated regularly for new shows and newly discovered items.

8. An entertainment system comprising:
a storage unit;
software written in one or more computer codes and stored on computer readable media in the storage unit, the software having code segments to provide a graphical user interface to a viewer to select an object to obtain information about the object;
a first server configured receive inquiries from the viewer and retrieve information;
a second server configured to house links to items present in all entertainment and shows on channels that the system supports; and
a third server configured to distribute the viewer's request to a known source or preferred provider for purchase or fulfillment.

9. The purchasing system of claim 8, wherein the object is selected from the group consisting of songs, movies, videos, characters, architecture designs, biographies, homes, cars, furniture, designer clothes, decorative items, collectibles, autographed collectables, and video games.

10. The purchasing system of claim 8, wherein the information is selected from the group consisting of decorators, designers, architects, engineers, actors, decorators, services, manufactures, availabilities, contact information, cost, articles, videos, biographies, and fact checks.
